(19) United States
(12) Patent Application Publication
(10) Pub. No.: US 2021/0322242 A1
(43) Pub. Date: Oct. 21, 2021

(54) PORTABLE PATIENT ISOLATION SYSTEMS AND METHODS

(71) Applicant: Regents of the University of Minnesota, Minneapolis, MN (US)

(72) Inventors: Christopher Hogan, Minneapolis, MN (US); Hai-Thien Phu, West Saint Paul, MN (US); Asish Abraham, Saint Louis Park, MN (US); Kumar Belani, Saint Louis Park, MN (US); Austin Andrews, Minneapolis, MN (US); Ian Marabella, Wyoming, MN (US); Bernard Olson, Arden Hills, MN (US); Yensil Park, Minneapolis, MN (US); Thomas Dufresne, West Saint Paul, MN (US)

(73) Assignee: Regents of the University of Minnesota, Minneapolis, MN (US)

(21) Appl. No.: 17/231,341

(22) Filed: Apr. 15, 2021

Related U.S. Application Data
(60) Provisional application No. 63/010,880, filed on Apr. 16, 2020.

(51) Int. Cl. A61G 10/00

(52) U.S. Cl. CPC A61G 10/005; A61G 10/04

(57) ABSTRACT

Respiratory isolation systems and devices for facilitating delivery of respiratory treatments to a patient. The device incudes a housing, a filtration unit, and at least one access port. The housing includes a front panel, a rear panel, one or more side panels, and a top panel that combine to define a chamber. The housing defines an open base that is open to the chamber, and the front panel defines an opening to the chamber. The filtration unit is mounted to the housing and includes a filter in fluid communication with the chamber. The access port is formed through one of the panels and permits user access to the chamber from an exterior of the housing. When connected to an airflow source as part of a respiratory isolation system, negative or positive pressure can continuously be provided to a patient within the chamber.

### CROSS-REFERENCE TO RELATED APPLICATIONS

This Non-Provisional patent application claims the benefit of the filing date of U.S. Provisional Patent Application Ser. No. 63/010,880, filed Apr. 16, 2020, entitled “PORTABLE PATIENT ISOLATION SYSTEMS AND METHODS,” the entire teachings of which are incorporated herein by reference

### BACKGROUND

The present disclosure relates to patient and health care worker protection. More particularly, it relates to portable systems that establish a respiratory isolation zone about a patient, and related methods of use.

Numerous patient healthcare scenarios present concerns over airborne particles or droplets exhaled (or otherwise emitted from the respiratory system) and/or inhaled by the patient. For example, a patient suffering from a communicable disease may transmit the disease to a nearby health care worker through aerosolized respiratory secretions that may otherwise contain infectious microbes or particles. Moreover, certain procedures performed by the health care worker on the patient inherently increase the likelihood of the patient emitting respiratory droplets/aerosolized particles.

To address these and other risks, various recommended safety protocols have been instituted for isolating patients known or suspected to be infected with a communicable disease at a health care provider's facility. Where possible, the patient is placed in an airborne infection isolation room (AIIR). An AIIR is typically a standalone, single-occupancy patient-care room within a healthcare provider's facility used to isolate persons with a suspected or confirmed airborne infectious disease. Environmental factors are controlled in the AIIR to minimize the transmission of infectious agents that are usually transmitted from person to person by droplet nuclei associated with coughing or aerosolization of contaminated fluids. A primary feature of an AIIR is the provision of negative air pressure in the room, with air being exhausted from the room passing through an appropriate filter (e.g., high-efficiency particulate air, or HEPA, filter). When airborne infection isolation is needed and there are no available or insufficient AIIRs (such as can happen when there is an outbreak of an airborne infectious disease with large numbers of communicable patients), a curtain temporary negative pressure isolation room or enclosure can be established by, for example, hanging plastic sheeting from a ceiling of the patient's room and connecting the intake from a portable HEPA filter machine within the so-created enclosure.

In some situations, an AIIR or similar negative pressure room or enclosure may not be available. Further, while AIIRs and similar installations are highly viable approaches for limiting exposure risks to persons located outside of the isolation room or area, no such protection is afforded to a health care worker within the isolation room. In many scenarios, personal protective equipment (PPE) such as a mask (e.g., N95 respirator mask), gown, gloves, etc., worn by the health care worker can provide adequate protection against aerosolized respiratory secretions when performing a procedure on a patient. However, appropriate PPE may not always be available. Also, standard PPEs may be deemed insufficient when interfacing with a patient suffering from a highly contagious disease, especially when performing procedures likely to generate respiratory secretions. These and other factors may overtly impact the format or type of care that can safely be provided.

As a point of reference, a number of well-accepted treatment options are available for treating a patient suffering from a respiratory illness while at a health care provider's facility, each with differing degrees of complexity, care requirements, and/or cost. One such treatment option is non-invasive ventilation (NIV), such as non-invasive positive-pressure ventilation (NIPPV). NIPPV is a type of mechanical ventilation to patients with respiratory failure that does not require an artificial airway, and is thus has less rigorous time and care provider requirements as compared to invasive techniques (e.g., endotracheal tube or tracheostomy tube). Thus, NIPPV treatment is a desirable treatment option. However, certain circumstances may limit the availability of this otherwise available treatment. By way of non-limiting example, COVID-19 is a highly contagious respiratory illness. Due to the relatively high likelihood of significant aerosolization of a patent's respiratory secretions with NIPPV, the Center for Disease Control recommends against the use of NIPPV during active COVID-19 infection. Thus, an early intubation policy was adopted for COVID-19 patients with respiratory failure, bypassing the less costly NIPPV care and requiring the patient be located in an intensive care unit for an extended time. Further, extubation of these same patients, who under normal circumstances would be supported by NIPPV, was also not recommended due to the risk of aerosolized spread of the virus and increased exposure to surrounding health care providers. Other diseases (e.g., tuberculosis, influenza, etc.) may present similar concerns.

Numerous other scenarios can arise where the inability to consistently prevent or control the release of exhaled, aerosolized particles or droplets from a patient to the surrounding environment presents unreasonable risks to nearby health care workers and others. Conversely, patients who might otherwise benefit from breathing treated air (e.g., filtered air, humidified air) may not be able to receive such treatment due to the inability to reasonably provide the necessary, controlled environment for the patient.

### SUMMARY

The inventors of the present disclosure recognized that a need exists for addressing the problems associated with environmental protection for respiratory care patients.

### BRIEF DESCRIPTION OF THE DRAWINGS

FIG. 1 is a perspective view of a respiratory isolation device in accordance with principles of the present disclosure;

FIG. 2A is a simplified cross-sectional view of the respiratory isolation device of FIG. 1;

FIG. 2B is a simplified cross-section view of the respiratory isolation device of FIG. 1 from a direction opposite the direction of FIG. 2A;

FIGS. 3A and 3B are perspective views of a respiratory isolation device in accordance with principles of the present disclosure carried by a cart;

FIG. 4 is a schematic diagram of a respiratory isolation system in accordance with principles of the present disclosure;

FIG. 5 is a simplified cross-section view illustrating airflow through the respiratory isolation device of FIG. 1 when used as part of the system of FIG. 4;

FIGS. 6A and 6B are perspective views of the respiratory isolation device of FIGS. 3A and 3B arranged over a patient, along with a health care worker interfacing with the patient; and

FIG. 7 is a perspective view of another respiratory isolation device in accordance with principles of the present disclosure and arranged over a patient.

### DETAILED DESCRIPTION

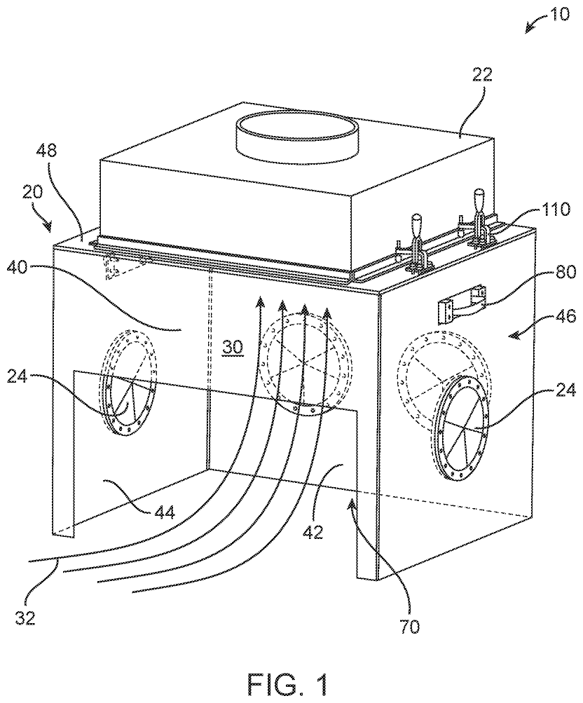

Aspects of the present disclosure relate to systems, devices and methods for providing environmental protection with respiratory care patients, for example reducing aerosolization within a portable aerosol hood or enclosure from respiratory support devices and aerosol generating procedures for augmentation of provider protective equipment (PPE). With this in mind, one embodiment of a portable respiratory isolation device 10 in accordance with principles of the present disclosure. The respiratory isolation device 10 includes a housing or hood 20, a filtration unit 22, and one or more access ports 24. Details on the various components are provided below. In general terms, the housing 20 is sized and shaped for placement onto a surface supporting a reclined patient, creating an isolation zone 30 (referenced generally) about at least the patient's head and neck (and thus encompassing the patient's mouth and nose). Forced airflow from a blower (not shown) is directed from (and/or to) the isolation zone 30 via the filtration unit 22, with a filter of the filtration unit 22 filtering the so-directed air. As a point of reference, in the non-limiting example of FIG. 1, arrows 32 indicate airflow to the filtration unit 22 (and thus a negative pressure within the isolation zone 30). With this mode of operation, for example, substantially all particles, droplets, etc., emanating within the isolation zone 30 (e.g., respiratory excretions from a patient's mouth and nose) are forced through filtration unit 22 and do not escape to the surrounding environment. Finally, the port(s) 24 provide a health care worker, for example, the ability to directly interface with a patient stationed within the isolation zone 30 in a manner than does not affect desired airflow from/to the filtration unit 22. When provided as part of a respiratory isolation system of the present disclosure, the portable respiratory isolation device 20 facilitates, for example, the performance of most, if not all, desired respiratory treatments on a patient (e.g., any non-invasive ventilation oxygen support) without risk of aerosolized particles or droplets from the patient's respiratory system coming in contact with the health care worker or otherwise escaping to the surrounding environment as described in greater detail below. In other embodiments, the systems and devices of the present disclosure can be utilized to provide non-invasive respiratory care to a patient.

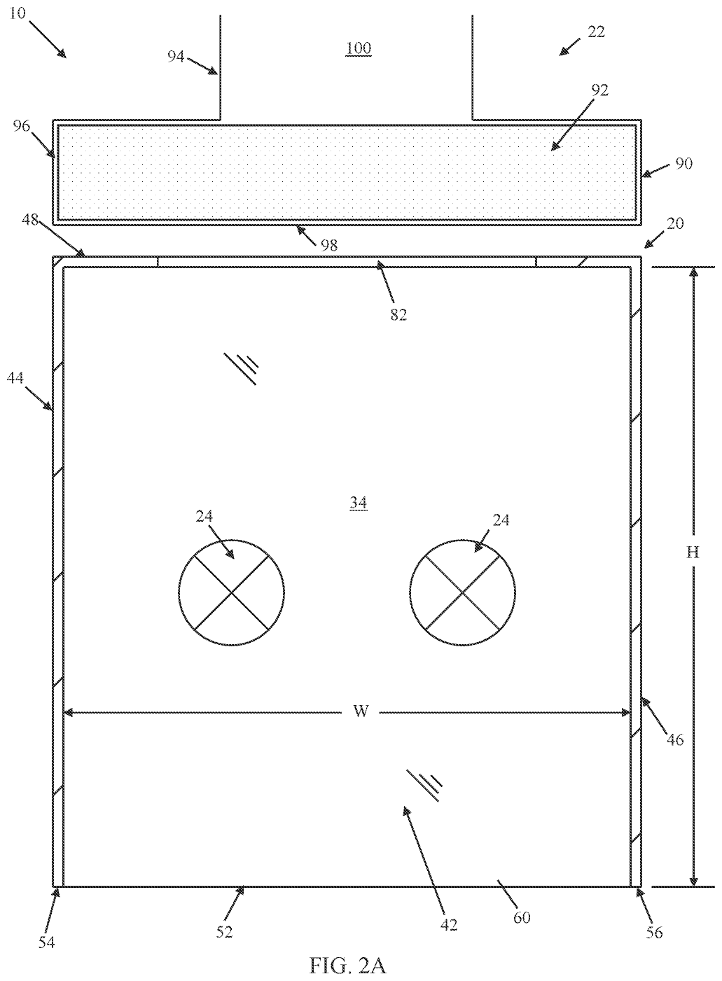

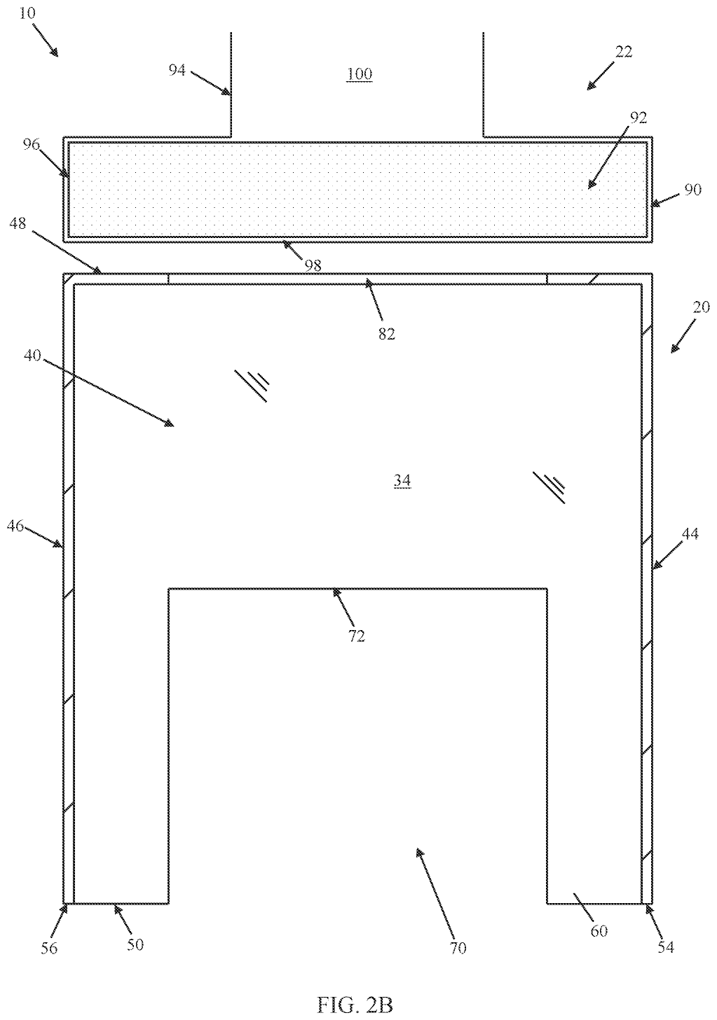

The housing 20 can assume various forms and generally includes one or more panels. With the non-limiting example of FIG. 1, the housing includes a front panel 40, a rear panel 42, opposing, first and second side panels 44, 46, and a top panel 48. With additional reference to FIGS. 2A (simplified cross-sectional view in which the rear panel 42 is visible) and 2B (simplified cross-sectional view which the front panel 40 is visible), the panels 40-48 combine to define a chamber 34. As described in greater detail below, a bottom opening to the chamber 34 is formed opposite the top panel 48; when the housing 20 is placed on a surface, that surface effectively closes the bottom opening, thus completing the isolation zone 30. At least the front, rear, and side panels 40-46 are formed of a rigid, sterilizable, and substantially transparent (i.e., within 10% of truly transparent) material that is impervious to air and bacterial sub-particles (e.g., virions). For example, the at least the front, rear, and side panels 40-46 can be polycarbonate. The top panel 48 may or may not be made of the same material as the front, rear, and side panels 40-46, but need not necessarily be substantially transparent.

The panels 40-48 can be assembled to one another in various fashions (e.g., plastic welding), with corners or connections between immediately adjacent ones of the panels 40-48 being configured to prevent the passage of air, bacterial sub-particles, etc. An overall construction of the housing 20 (e.g., wall thickness of the panels 40-48, welding or other connection format, etc.) is selected to robustly support a weight of the filtration unit 22 and remain stable when placed on a relatively flat surface. At least the front, rear and side panels 40-46 can be substantially flat or linear (i.e., within 10% of a truly flat shape). The front, rear and side panels 40-46 can have an identical or nearly identical height (e.g., distance of extension from the top panel 48), and each terminate at a free edge 50, 52, 54, 56, respectively, opposite the top panel 48. The free edges 50-56 are substantially co-planar (i.e., within 10% of a truly co-planar relationship), such that when placed on a relatively flat surface, the housing 20 is stable and will not readily tip. Thus, the free edges 50-56 define an open base 60 (referenced generally) of the housing 20 (e.g., the housing 20 is free of a panel or floor extending across or interconnecting the free edges 50-56 in a manner that might otherwise restrict access to an interior of the housing 20 via the open base 60).

In some embodiments, the free edge 52-56 of each of the rear and side panels 42-46 is substantially linear or continuous (i.e., within 10% of a truly linear shape) in extension between the corresponding, immediately adjacent panels 40-46. In other words, the rear and side panels 42-46 are, in some embodiments, continuous from the top panel 48 to the base 60 (apart from any opening or hole formed therein as part of an access port(s)). Conversely, and as best identified in FIG. 2B, an opening 70 is defined by or in the front panel 40. For example, the free edge 50 of the front panel 40 can be viewed or defined as having a recessed segment 72 that is spaced from the base 60. The opening 70 in the front panel 40 is open to or continuous with the open base 60, and is sized and shaped (e.g., height and width) to receive, or for placement about, an upper body of a human adult (i.e., the width of the opening 70 (distance perpendicular to the side panels 44, 46) is greater than the shoulder width of a typical human adult). In some non-limiting examples, the opening 70 can have a height on the order of 26 inches (66 centimeters). Along these same lines, other dimensions of the housing 20 are selected in accordance with human adult form factors and likely end-use environments (e.g., size of a typical health care institution bed on which a patient will be stationed), while maintaining a small, overall footprint (to enhance portability of the device 20). For example, and with reference to FIG. 2A, the housing 20 can be sized and shaped to form the chamber 34 to have a height H in the range of 12-48 inches (30-122 centimeters), for example on the order 24 inches (61 centimeters). A width W of the chamber 34 can be in the range of 18-48 inches (46-122 centimeters), for example on the order of 24 inches (61 centimeters). A length of the chamber 34 is defined perpendicular to the width W, and can be in the range of 18-48 inches (46-122 centimeters), for example on the order of 24 inches (61 centimeters). Other dimensions are also acceptable.

While the housing 20 has been shown and described has having a box or cube-like shape, other configurations or shapes are also acceptable. For example, the housing 20 can have more or less of the panels 40-46, and one or more of the panels 40-46 need not be substantially flat and/or need not be rigid. For example, the housing 20 can alternatively have a cylindrical or cylindrical-like shape. In some embodiments, the housing 20 can be integrally formed (e.g., molded, 3D printed, etc.). Regardless, the housing 20 provides the open base 60 as well as the opening 70 at a front side thereof.

As indicated above, one or more of the access ports 24 can be formed by or assembled to one or more the panels 40-48. With the non-limiting example of FIG. 1, two of the access ports 24 are provided with the rear panel 42, and a single one of the access ports 24 is provided with each of the side panels 44, 46. Regardless of number and location, the access port(s) 24 can have an identical construction, and are configured to facilitate access to the chamber 34 by a user's hand in an manner that optionally does not comprise an integrity of the chamber 34 (e.g., when a user's hand is placed through the access port 24, airflow, particles, etc., within the chamber 34 cannot escape to the external environment through the access port 24 in some non-limiting examples). In some embodiments, the access port(s) 24 is, or is akin to, an iris port. As is understood by one of ordinary skill, an iris port can include or consist of a stable ring (e.g., polyethylene ring) that is assembled to the corresponding panel 40-46, and two (or more) slotted discs (e.g., silicone discs) attached inside the ring. The overlapping segments of the crosswise slotted discs allow at the same time easy access to the chamber 34 and minimize the air exchange when the access port 24 is not in use. In other embodiments, the access port(s) 24 can be or include a glove port or glove box as is known in the art. In yet other embodiments, the access port(s) 24 can include a flexible material body (e.g., curtain, drape, sheet, etc.) permanently or selectively extending over a passage or opening in the corresponding panel 40-48. In some examples, the flexible material body can be formed or provided as a substantially transparent, liftable, good quality, durable strength drape. With these and related examples, a shape or size of the passage or opening in the corresponding panel 40-48 can be greater than those reflected by the drawings. In related embodiments, the panel 40-48 can be configured to permit a user to expand or contract a size of the opening to which the flexible material body covers. In some embodiments, the flexible material body can drape, slide or hang over the opening in the corresponding panel 40-48. Regardless, the flexible material body handing or otherwise covering an opening in the panel can allow a health care worker easy access a patient's airways (while located within the isolation zone 30) while a negative pressure established in the isolation zone 30 (as described below) still keeps aerosols in the isolation zone 30 moving to the filtration unit 22. With these and related embodiments, a size of the housing 20 can be adjusted or selected to “fit” differently-sized beds and there can be suitable features to keep it stable on the bed.

The housing 20 can optionally include or provide one or more additional features. For example, as shown in FIG. 1, a handle 80 can be assembled to or formed by one or both of the side panels 44, 46. Other handling structures are also envisioned. The housing 20 can further be configured or incorporate features that facilitate adjusting a size (or effective size) of the opening 70 in the front panel 40. For example, a releasable fastener (e.g., hook-and-loop material such as Velcro®) can be secured to the front panel 40 above the opening 40 for selectively maintaining a curtain (e.g., cloth towel) or similar body that drapes over the opening 70. Alternatively, the housing 20 can include or carry one or mechanisms that operate to physically block portions of the opening 70.

In additional to maintaining an overall structural integrity of the housing 20, the top panel 48 is configured support and interface with the filtration unit 22. With reference to FIGS. 2A and 2B, the top panel 48 has a size and shape corresponding with a footprint of the filtration unit 22, and defines an aperture 82. The aperture 82 is open to the chamber 34. Upon final assembly of the filtration unit 22 to the top panel 48, the aperture 82 facilitates passage of airflow between the chamber 34 and the filtration unit 22.

The filtration unit 22 can have various forms, and generally includes a frame 90, a filter 92, and a head 94. The frame 90 defines a plenum 96 sized and shaped to encase the filter 92, and is formatted for assembly to the top panel 48. Further, the frame 90 defines an inlet 98 that is open to the plenum 96 (and thus to the filter 92). The head 94 extends from the frame 90 opposite the inlet 98, and defines a passage 100 that is open to the plenum 96. An exterior shape of the head 94 is configured to releasably receive a duct or similar body (e.g., a flexible air duct) otherwise fluidly connected to a blower (not shown) in a manner that fluidly connects the duct with the passage 100 in a sealed manner. Upon final assembly, then, air can flow from the inlet 98 to the head passage 100, and vice-versa, and must pass through the filter 92.

The filter 92 can be any filter media or format deemed appropriate for a particular end use application. In some embodiments, the filter 92 is or includes a HEPA filter (e.g., a 2 foot by 2 foot HEPA filter) as is known in the art. Alternatively or in addition, the filter 92 can be or include an electrostatic precipitator formatted to collect particles, and activated carbon packed bed to remove VOCs, etc., with one or more of these alternative constructions serving as a “filter” differing from a conventional “filter media”.

One or both of the housing 20 and the filtration unit 22 can include or carry features that promote releasable assembly of the filtration unit 22 to the top panel 48. For example and as shown in FIG. 1, one or more clamps 110 can be mounted to the top panel 48, and are operable to fasten the filtration unit 22 to the top panel 48. With these and similar configurations, the filtration unit 22 can be removed from the housing 20 on a periodic basis to, for example, replace the filter 92.

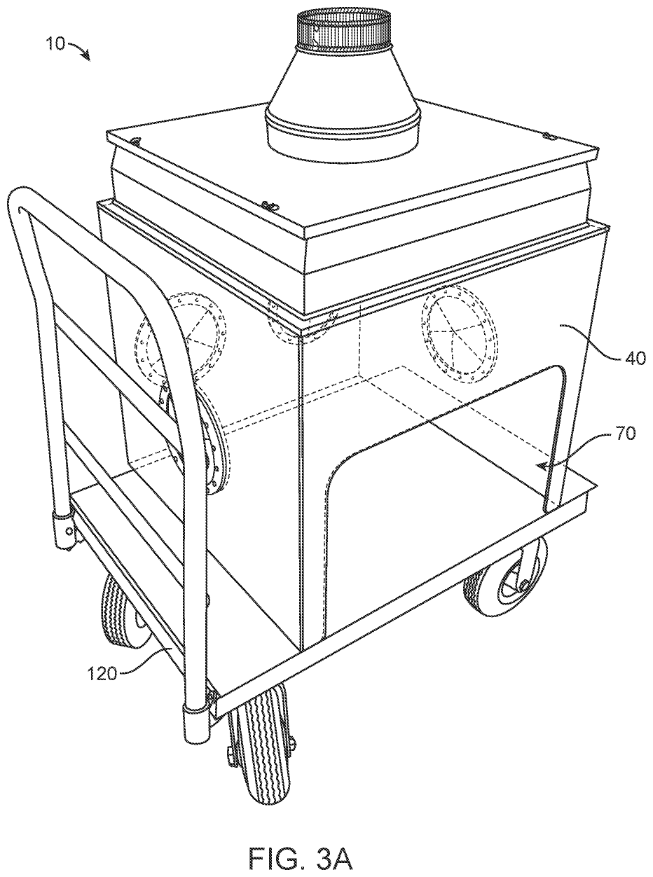

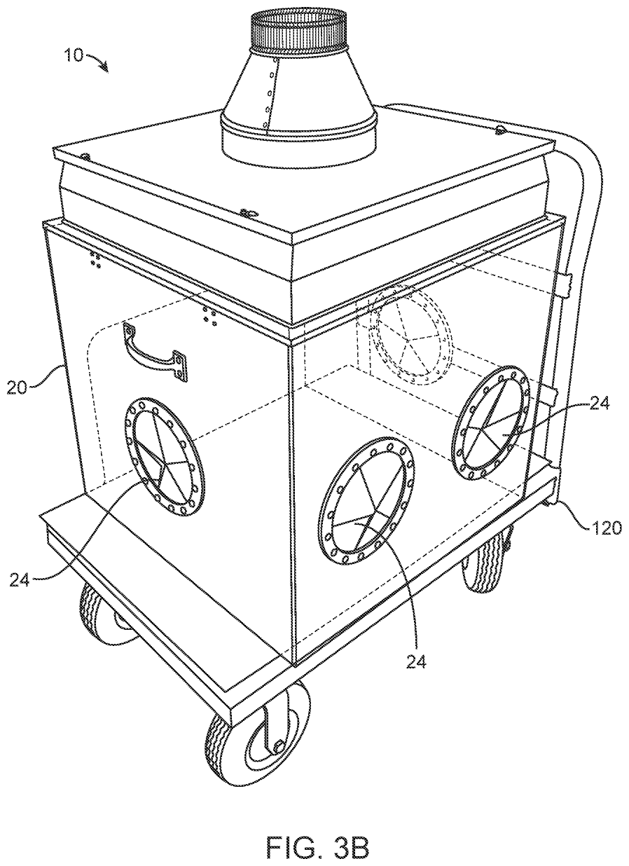

One non-limiting example of the respiratory isolation device 10 is shown in FIGS. 3A and 3B. As a point of reference, in the views of FIGS. 3A and 3B, the respiratory isolation device 10 is placed on a standard wheeled cart 120, illustrating the portability of the device 10. However, the cart 120 is not required; instead, the respiratory isolation device 10 can simply be carried by a user to a desired location. Regardless, the front perspective view of FIG. 3A shows the opening 70 in the front panel 40, whereas optional locations of the access ports 24 relative to a height of the housing 20 is best reflected in FIG. 3B. Further, an optional configuration of the head 94 is shown in the views, well-suited for connection with a blower duct (not shown) as is known in the art.

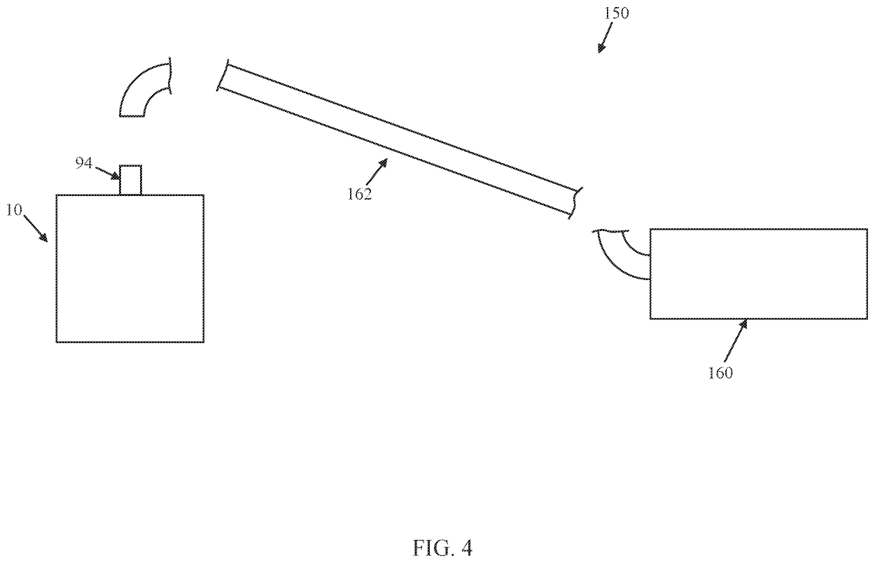

FIG. 4 schematically illustrates the respiratory isolation device 10 as part of a respiratory isolation system 150 in accordance with principles of the present disclosure. The system 150 further includes an airflow source 160 and a duct 162. The airflow source 160 can have a variety of forms appropriate for generating forced airflow and/or pressure, and in some embodiments is a blower, such as a high speed blower of a type known in the art capable of generating airflow rates of at least 2 ft³/min (60 liters/min). In some examples, the airflow source 160 is a multi-speed blower of a type known in the art capable of generating airflow rates on the order of at least 100 ft³/min (2832 liters/min), alternatively in the range of 300-400 ft³/min (8500-11,300 liters/min). Other airflow source formats are also acceptable. Regardless, in some embodiments, the airflow source 160 can be selected to generate relatively minimal noise during operation, for example noise levels not greater than 60 dB.

The duct 162 can have any form conventionally employed with airflow delivery applications and appropriate for installation to the airflow source 160. In some embodiments, the duct 162 can be a conventional flexible duct. As reflected by FIG. 4, a length of the duct 162 can vary, and in some embodiments can be selected by an end user (e.g., health care institution) based upon facility requirements or lay-out.

During use, the blower or other airflow source 160 can be permanently or temporarily installed at a location remote from the patient for whom respiratory therapy or treatment will be applied. For example, the airflow source 160 can be centrally located in a room or other facility locale at an appreciable distance from the patient. The respiratory isolation device 10 is carried or otherwise manually transported to the patient's location, and installed over the patient's upper body as described in greater detail below. The duct 162 is connected to both the airflow source 160 and the head 94. The airflow source 160 is then operated to draw air from the respiratory isolation device 10, or optionally to force air to the respiratory isolation device 10 depending upon the particular procedure being performed.

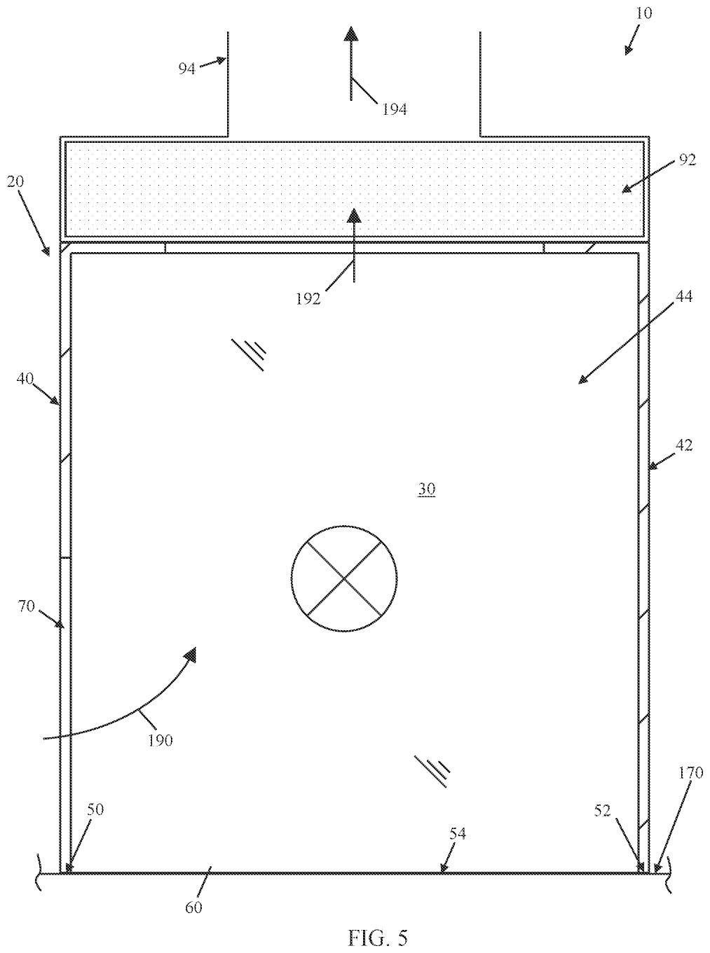

For example, FIG. 5 is a simplified representation of the respiratory isolation device 10 placed on a surface 170 (e.g., a bed such as a conventional hospital bed or support). The free edges of the panels rest on the surface 170 (in the orientation of FIG. 5, the leading edge 50 of the front panel 40, the leading edge 52 of the rear panel 42, and the leading edge 54 of the side panel 44 are identified), rendering the respiratory isolation device 10 stable. With this arrangement, the surface 170 serves to close the open base 60, thus completing the isolation zone 30. However, the opening 70 in the front panel 40 remains open to the isolation zone 30. When the airflow source 160 (FIG. 4) is fluidly connected to the head 94 by the duct 162 (FIG. 4) and operated to draw or pull airflow, a negative pressure is established in the isolation zone 30, with air continuously being drawn into the isolation zone 30 via the opening 70 (represented by arrow 190) and to the filter 92 (represented by arrow 192). All airborne particles or droplets generated within the isolation zone 30 are entrained in the airflow and delivered to filter 92; the filter 92, in turn, functions to remove the particles and droplets from the airflow, resulting in clean airflow (represented by arrow 194) progressing along the duct 162 to the airflow source 160 and exhausted to the environment. Thus, airflow out of the respiratory isolation device 10 will be free of particles (e.g., viral particles). Conversely, when the airflow source 160 is optionally operated to deliver or force airflow to the respiratory isolation device 10 (e.g., establish a positive pressure within the isolation zone 30), the so-delivered airflow is filtered or otherwise treated at the filter 92 before entering the isolation zone 30 (and thus interfacing with a patient's mouth and nose, for example, otherwise located within the isolation zone), and then exits via the opening 70.

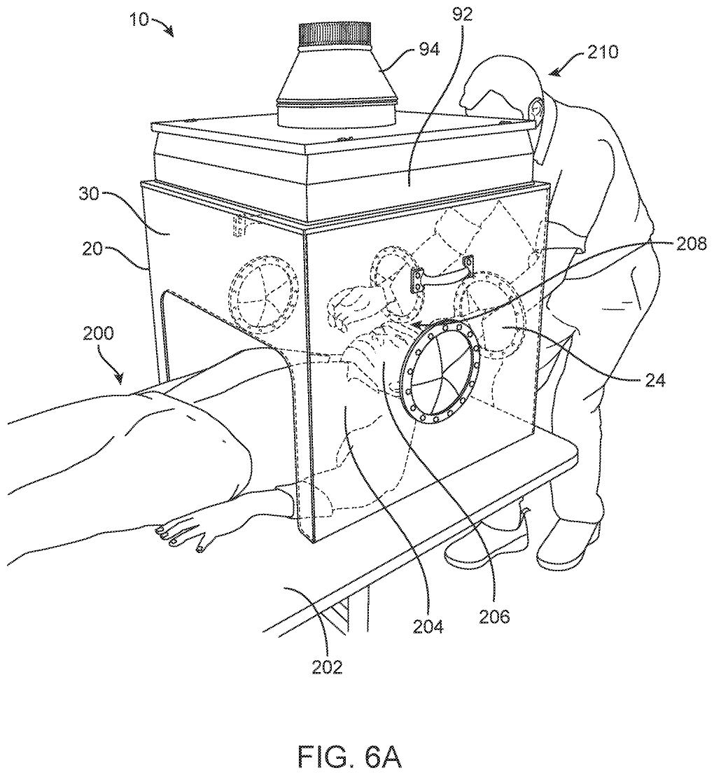

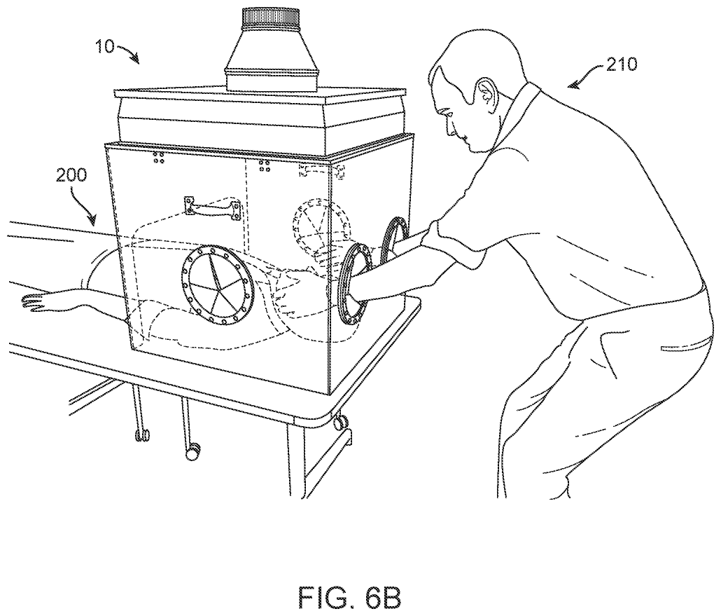

FIG. 6A shows one example of placement of the respiratory isolation device 10 relative to a patient 200. The patient 200 is reclined or prone on a surface or support 202, for example a support commonly used by health care providers (e.g., a hospital bed). The respiratory isolation device 10 has been manually located on the surface 202 such that an upper body 204 of the patient 200 is comfortably within the isolation zone 30 (referenced generally). While a size and shape of the housing 20 can vary (as can the size of the particular patient), at least a mouth 206 and a nose 208 of the patient 200 is within the isolation zone 30. When a constant negative pressure is established within the isolation zone 30 as described above (i.e., the head 94 is connected to a duct (not shown) that in turn is connected to a blower or other airflow source operating to draw air), virtually all, if not all, particles, droplets, etc., generated by the patient's respiratory system and emanating from the mouth 206 and/or nose 208 are within the isolation zone 30 and thus entrained into the airflow. All of the particle/droplet-laden airflow is directed to the filter 92 (referenced generally) that removes the particles, droplets, etc. as described above.

FIG. 6A further reflects that a heath care worker 210 (or other user) can directly interface with the patient 200 with the respiratory isolation device 10 in place. In particular, the heath care worker 210 can extend his or her hand/arm through one (or more) of the access ports 24, and can, for example, perform procedures (e.g., respiratory-related procedures) requiring direct access to one or both the patient's mouth 206 and nose 208. With continuous operation of the airflow source 160 (FIG. 4) and thus continuous flow of air into the isolation zone 30 and then to the filter 92, any portion of the health care worker's body outside of the housing 20 will not be exposed to particles, droplets, etc., emanating from the patient's respiratory system; the access port(s) 24 is effectively sealed about the health care worker's arm, preventing the particles, droplets, etc., from escaping to the external environment. FIG. 6B further illustrates the safe nature in which the health care worker 210 can interface with the patient 200 with the respiratory isolation device 10 in place.

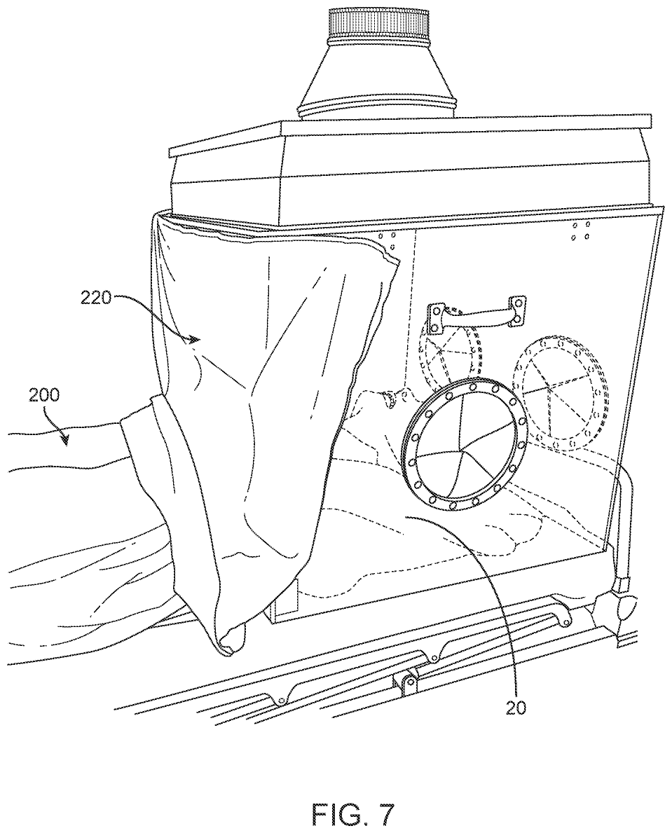

As mentioned above, in some non-limiting embodiments, the respiratory isolation devices and systems of the present disclosure optionally afford a health care worker with the ability to reduce a size of the opening 70 (FIG. 1) in the front panel 40 (FIG. 1). For example, FIG. 7 illustrates an optional embodiment of the present disclosure in which a curtain 220 has been temporarily fastened to the housing 20 and drapes over the patient 200 and the opening (hidden in the view). The curtain 220 can be fastened to the housing 20 after the housing 20 has been placed over the patient 200 in a desired arrangement.

The respiratory isolation devices and systems of the present disclosure are useful in facilitating performance of, and/or can perform, a plethora of treatment procedures at a desired location due, at least in part, to the portability of the respiratory isolation device 10. For example, with the airflow source 160 (FIG. 4) operating to draw air through and from the isolation chamber 30 (FIG. 1), the respiratory isolation devices and systems of the present disclosure can serve to augment the provider protective equipment (PPE) utilized or worn by a health care worker when interfacing with a patient to perform a respiratory-related procedure, such as a patient suspected or known to have contracted a communicable virus or disease. In some examples, the health care worker can safely apply non-invasive ventilation (NIV) (e.g., high flow nasal cannula), including any NIPPV (CPAP mask, nasal cannula, etc.), to a patient suffering from a contagious respiratory illness with minimal, if any, risk that aerosolized particles emitted from the patient's respiratory system will come into contact with the health care worker outside of the isolation chamber 30. Further, NIV (including NIPPV) can be continuously provided to a patient suffering from a contagious respiratory illness with minimal, if any, risk that aerosolized particles emitted from the patient's respiratory system will escape into the external environment outside of the isolation chamber 30. These and other benefits can be highly useful in multiple circumstances, for example making less invasive, health care facility-provided respiratory treatments viable for patients known or believed to be suffering from a contagious respiratory illness when existing protocols advise against such treatments (e.g., coronavirus, tuberculosis, influenza, any microbial transmission through the airways, etc.). Similarly, where existing protocols advise against NIV (such as NIPPV) due to risk of possible exposure to respiratory microbes, an intubated patient known or suspected to be suffering from a contagious respiratory illness can be extubated more quickly, and progressed to NIPPV. The risks presented to health care workers (and others) associated with many other procedures, such as nasopharyngeal swab testing for the detection of microbes, dental procedures, central lines placement, bronchoscopies, etc., can also be reduced or mitigated with the respiratory isolation devices and systems of the present disclosure.

Alternatively or in addition, with the airflow source 160 (FIG. 4) operating to force air to and through the isolation chamber 30 (FIG. 1), the respiratory isolation devices and systems of the present disclosure can operate to provide positive pressure treatment or therapy to a patient. As a point of reference, while various NIV and NIPPV techniques and the like are well-accepted, certain patients may not be comfortable with the equipment involved (e.g., mask, cannula, etc.), especially when required to wear the equipment for longer periods of time. Positive pressure therapy can be continuously provided to a patient when located with the isolation chamber 30 as described above. In this regard, the delivered air can be filtered as desired or subjected to other treatments, such as humidification. Patients suffering from maladies such as asthma, environmental allergies, etc., can benefit from the devices and systems of the present disclosure.

Although the present disclosure has been described with reference to preferred embodiments, workers skilled in the art will recognize that changes can be made in form and detail without departing from the spirit and scope of the present disclosure. For example, in some embodiments, the respiratory isolation device has been shown and described as having a housing sized and shaped for provision of one or two access ports on or more of the panels. In other embodiments, a size of the housing can be expanded and additional access ports provided. With these and related embodiments, the respiratory isolation device and corresponding systems can be employed with surgical procedures to provide a negative pressure environment and augmenting health care worker protection.

What is claimed is:

1. A respiratory isolation device comprising:
a housing including a front panel, a rear panel, one or more side panels, and a top panel, wherein:
the panels combine to define a chamber,
the housing defines an open base that is open to the chamber,
the front panel defines an opening to the chamber;
a filtration unit mounted to the housing and including a filter in fluid communication with the chamber; and
an access port formed through one of the panels and configured to permit user access to the chamber from an exterior of the housing.

2. The respiratory isolation device of claim 1, wherein the filtration unit further includes a frame containing the filter and a head extending from the frame, the head defining a passage fluidly open to the filter.

3. The respiratory isolation device of claim 2, wherein the head is configured for releasable assembly to a duct.

4. The respiratory isolation device of claim 1, wherein the filter is a HEPA filter.

5. The respiratory isolation device of claim 1, wherein the front, rear and side panels are substantially transparent.

6. The respiratory isolation device of claim 1, wherein the respiratory isolation device is configured to be portable.

7. The respiratory isolation device of claim 1, wherein the access port is selected from the group consisting of an iris port and a gloved port.

8. The respiratory isolation device of claim 1, wherein the access port is a first access port formed through a first one of the panels, the respiratory isolation device further comprising:
a second access port formed through a second one of the panels.

9. The respiratory isolation device of claim 1, wherein the access port is a first access port formed through a first one of the panels, the respiratory isolation device further comprising:
a second access port formed through the first one of the panels.

10. A respiratory isolation system comprising:
the respiratory isolation device of claim 1;
an airflow source; and
a duct for fluidly connecting the respiratory isolation device with the airflow source.
